(19) United States
(12) Patent Application Publication
(10) Pub. No.: US 2022/0111417 A1
(43) Pub. Date: Apr. 14, 2022

(54) PHASED ARRAY EMAT TRANSDUCER FOR GENERATION OF SHEAR HORIZONTAL WAVES

(71) Applicant: Borja Lopez Jauregui, Lynchburg, VA (US)

(72) Inventor: Borja Lopez Jauregui, Lynchburg, VA (US)

(21) Appl. No.: 17/070,531

(22) Filed: Oct. 14, 2020

(51) Int. Cl. B06B 1/04; B06B 1/02; G01N 29/04

(52) U.S. Cl. CPC B06B 1/045; B06B 1/0215; G01N 29/041; G01N 2291/267; B06B 2201/53; B06B 2201/72; G01N 2291/0422; B06B 2201/54

(57) ABSTRACT

A system for non-destructive inspection that generates Shear Horizontal waves in phased array configuration using an Electro Magnetic Acoustic Transducer (EMAT). The system includes an EMAT transducer with a plurality of elements made of individually wound elements under a single magnetic field, and an instrument to pulse, receive and record the signals from each element separately. Each wired element in the array generates shear waves perpendicularly to the coil windings which radiate around the elements' long axis. By phasing the pulsing and receiving of the individual elements, the beam can be electronically focused at different angles in the component from 0° to +/−90°. The compact distribution of the array permit using relatively high frequencies without generating deleterious grating lobes.

### BACKGROUND OF THE INVENTION

The present invention relates generally to the field of non-destructive testing and in particular to Electromagnetic Acoustic Transducer (EMAT).

EMAT or Electro Magnetic Acoustic Transducer is an Ultrasonic Testing (UT) technique that generates the sound in the part inspected instead of the transducer. An EMAT induces ultrasonic waves into a test object with two interacting magnetic fields. A relatively high frequency (RF) field generated by electrical coils interacts with a low frequency or static field generated by magnets to generate a Lorentz force in a manner similar to an electric motor. This disturbance is transferred to the lattice of the material, producing an elastic wave. In a reciprocal process, the interaction of elastic waves in the presence of a magnetic field induces currents in the receiving EMAT coil circuit. For ferromagnetic materials, magnetostriction produces additional stresses that enhance the signals to much higher levels than could be obtained by the Lorentz force alone. Various types of waves can be generated using different combinations of RF coils and magnets.

One of the advantages of EMAT is the ability to generate Shear waves with horizontal polarization with respect to the plane of generation. These waves, referred commonly as Shear Horizontal waves, are very useful for non-destructive inspection since they are available at any angle from 0° to +/−90°, and do not mode convert when they strike surfaces perpendicular to the direction of polarization. These characteristics make them especially well-suited for inspection of welds in general, and in particular for inspection of welds with dendritic grain structures which cannot be penetrated with more conventional Shear Vertical waves.

The conventional EMAT design for generation of Shear Horizontal waves with Lorentz forces in phased array involves using a meander-type RF coil for each element of the array under permanent magnets with alternating poles to compensate for the change in direction of the meanders and maintain the polarity of each element constant. This construction has many limitations that affect performance and usability.

This disclosure introduces a novel Shear Horizontal EMAT transducer construction that addresses these limitations and produces superior signal-to-noise in a compact transducer package.

### SUMMARY OF THE INVENTION

In one aspect of the present invention, each RF coil representing an individual element in the array is built by wrapping a single layer coil of wire around and along a spool made out of a material that is highly resistive or, ideally, non-conductive. The size of each spool and wire element determines the pitch of the transducer array. For practical purposes, each spool and wire should have a diameter and thus array pitch between 0.5 mm and 5 mm that allows generation of shear waves in frequencies between 6 MHz and 600 kHz. The length of spool wired will determine the elevation or passive plane of the transducer. Each wired spool representing a single element in the transducer is placed aside others to create the array.

The array constructed in this manner is placed under a single, normal magnetic field covering the full array. When pulsed with alternating current, each wired spool generates eddy currents on the surface of the part which electromagnetically interact with the normal magnetic field to produce ultrasonic shear waves with polarization perpendicular to the wire windings.

These shear waves polarized perpendicularly to the windings radiate around the spool's long axis resulting in a wave front of shear waves with horizontal polarization from 0° to +/−90°.

By changing the time delay between the pulsing and receiving of each element, the beam can be steered electronically to focus at different angles in the part inspected with horizontally polarized shear waves.

### BRIEF DESCRIPTION OF THE DRAWINGS

FIG. 1 shows a conceptual drawing of a piezoelectric Shear Vertical array transducer. Each element in the transducer creates compression waves that enter the part at an angle and refract into shear waves between the first and the second critical angle.

FIG. 2A shows a conceptual drawing of a standard construction for a Shear Vertical EMAT transducer. The interaction between the magnetic and the electrical field generate a shear particle motion in the material perpendicular to the plane of generation thus creating a shear wave front with vertical polarization.

FIG. 2B shows the directivity pattern and relative strength of the wave at different angles when sweeping a Shear Vertical wave generated with EMAT, which is highest at +/−35° and weak or non-existing at other angles.

FIG. 3A shows a standard construction for a Shear Horizontal EMAT transducer. A meandering RF coil is positioned under a magnet array with alternating poles. The resulting shear wave is polarized parallel to the plane of generation thus creating a shear wave front with horizontal polarization.

FIG. 3B shows the directivity pattern and relative energy generated at different angles when sweeping a Shear Horizontal wave generated with EMAT, which is present at all angles from 0° to +/−90°.

FIG. 4 shows the conventional construction for a Shear Horizontal phased array EMAT with each meandering RF Coil element crisscrossed by magnets of alternating poles. The separate elements are combined to create a phased array. The construction requires using separate elements for transmission and reception which are positioned at an angle to address the area of interest.

FIG. 5A shows the RF coil array for the novel phased array transducer. The RF coil elements are made by individually winding spools with one wire or two wires to create a differential coil. The wound spools are placed side-by-side to form the array.

FIG. 5B shows the RF coil array under a normal magnetic field which generate shear forces perpendicular to the windings and radiating perpendicularly to the spool's long axis.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention relates to a phased array Electro Magnetic Acoustic Transducer (EMAT) capable of generating horizontally polarized shear wave energy for non-destructive inspection of conductive materials.

Shear wave refers to an ultrasonic wave mode in which the particle motion is perpendicular to the wave direction. Shear waves can be further differentiated by the polarization with respect to the plane of entry or generation into Shear Vertical and Shear Horizontal waves.

Shear Vertical waves are the most common shear mode used in non-destructive inspection. Shear Vertical waves are typically generated via mode conversion when a longitudinal wave generated with a piezoelectric element enters a solid medium at an angle and mode-converts at the boundary following Snell's law of refraction. Shear waves generated through refraction are polarized vertically from the plane of entry, and are only present from the first to the second critical angle of refraction which is typically between 30° and 60° from the plane of entry. Piezoelectric phased array shear wave transducers are also limited to electronic focusing within the two critical angles.

Shear Vertical waves can also be generated with EMAT transducers using a meandering RF Coil and a normal magnetic field overlapping the RF coil. The vectorial resultant of the electromagnetic forces generate a shear wave motion on a nearby electric conductor perpendicular to the direction of the wires of the RF coil. This beam can be steered up and down parallel to the direction of the RF coil thus maintaining the vertical polarization of the shear wave as it moves up and down the plane of generation. However, Shear Vertical waves generated with an EMAT in this manner are very strong at approximately 35° from the normal, but very weak or non-existing at other angles, which precludes this construction from being used in phased array.

Shear waves with horizontal polarization are much more rare and difficult to generate. Since shear energy does not propagate through liquids and horizontal polarization cannot be achieved through mode conversion, piezoelectric transducers cannot generate Shear Horizontal waves unless a purposely made shear transducer is firmly affixed to the part or coupled with a high-density, semi-solid couplant. Either solution impedes scanning the transducer on the part, which limits their usability.

EMAT transducers can be used to generate horizontally polarized shear waves at any angle from 0° to +/−90° using Lorentz forces. In the most standard construction, a meandering RF coil is placed under a magnet array with alternating north and south poles. The opposing magnet poles change the polarity of the RF coil at each meandering turn to maintain the same polarity across the transducer width or wave front. In a one channel transducer, additional rows are added to the same coil to strengthen the wave for a particular wavelength, which is determined by the distance from the center of one magnet pole to the center of the pole in the adjacent row multiplied by 2. The Shear Horizontal waves generated perpendicularly to the coil wires can then be steered by changing the frequency for a fixed wavelength. Shear Horizontal waves generated with this construction are available at all angles from 0° to +/−90°.

While Shear Horizontal waves are available at any angle, construction of an EMAT phased array transducer for this wave mode is particularly problematic. In prior art designs, each element RF coil meanders up and down with 180° turns across the width of the transducer under a periodic array of magnets with opposing polarities. Additional identical elements are placed on subsequent rows, which are pulsed and received at different times to provide electronic focusing.

The limitations of this phased array EMAT construction are many. First, the pitch or distance from element to element is limited by the practical minimum size for the permanent magnets in the array. The smallest size documented is 3 mm, which limits the frequency to approximately 1 MHz before deleterious grating lobes prevent inspection at angles over 45°. Second, the magnets and hence the whole transducer must be kept very close to the part since lift-off will cause the magnetic field to close from one magnet to the adjacent opposite pole without going through the part where it is needed to generate the ultrasound. On an array with magnets 3 mm in size, a distance of 50 μm from the magnets to the part can reduce the signal by as much as 10-15 dB. Third, magnet arrays with adjacent opposing poles cannot be electrically isolated from the RF coil, which causes the transmitter elements to interact and create strong reverberations in the electrically conductive magnets affecting the instrument readings. To avoid these reverberations, the standard solution is to physically separate the transmitter from the receiver elements in an angled or tandem array construction which results in larger and more difficult to use transducers.

In one embodiment of this invention, each individual RF coil is wired around a round spool of non-conductive material. The bottom area of the windings on the spool will generate eddy currents on the material, while the top portion provides the return path necessary to close the circuit. Since the top portion of the wires generates eddy currents in the opposite direction, it is beneficial to keep it farther away from the part

The diameter of each wired spool determines the size of the element and thus the minimum pitch of the transducer which should be kept as small as possible to avoid grating lobes when sweeping at higher frequencies. A 1 mm diameter spool with 30 AWG wire results in a transducer with 1.5 mm pitch which permits sweeping to +/−90° at shear wave frequencies of 2.0 MHz without generating grating lobes.

The wired spool is aligned side by side with other identically wired spools, with each wired spool being an element of the phased array transducer. The length of spool wired will determine the elevation of passive face of the transducer, which is typically kept between 10 mm and 50 mm. The number of elements on the transducer is only limited by the capabilities of the instrument. The most common number of elements are 8, 16, 32, and 64 but the construction is not limited to any particular number.

The complete wired spool array is placed under a single normal magnetic field which generates shear waves with particle motion perpendicular to the windings and radiating at all angles perpendicularly to the spool's long axis on each individual wired spool.

In some embodiments the spools are rectangular with the shorter side facing the part and the longer dimension facing up. This construction permits maintaining a small pitch while increasing the distance of the return wires from the material to reduce opposing eddy currents and increase signal-to-noise. In this case, it is desirable to use a soft magnetic material with high resistivity that can guide the magnetic flux from the top into the part while minimizing eddy current losses in the spool.

In some embodiments the spools and wires are replaced with a multi-layered printed circuit board to facilitate manufacturing and assembly.

In some embodiments the wire used to coil the spool is a single wire. In other embodiments a double wire is used with two ends tied together to become the ground in a differential coil construction that reduces common mode noise.

In some embodiments the normal magnetic field is generated with a single magnet, while in other embodiments the normal magnetic field is generated using magnet arrays to increase magnetic flux and signal-to-noise or electromagnets that can be turned off as needed. In all constructions, the field is always normal to the array. A single, large field is beneficial to have a strong magnetic flux going through the part, increase signal-to-noise, and reduce sensitivity to transducer lift-off.

In some embodiments all the elements of the transducer array are used to pulse and receive in a pulse-echo configuration. In other embodiments the transmitting elements are different from the receiving elements in a pitch-catch configuration.

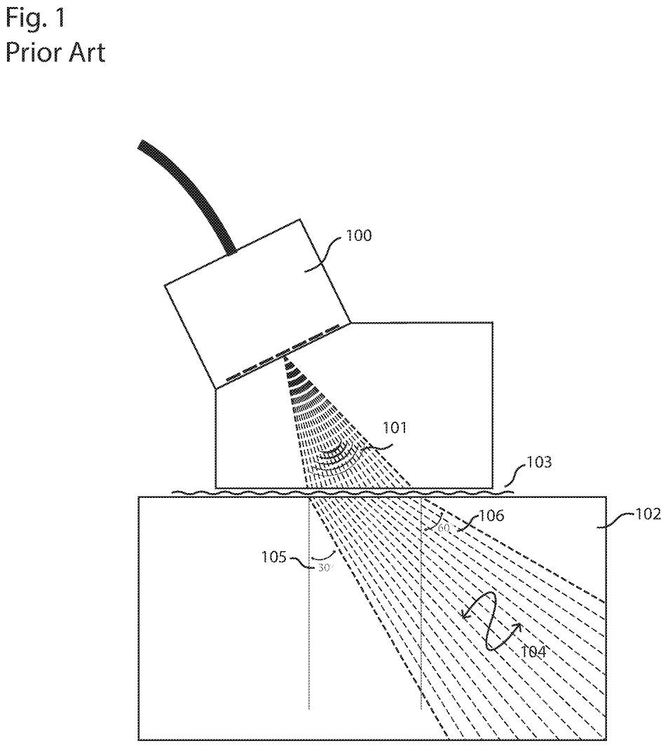

FIG. 1 shows a conceptual drawing of a piezoelectric Shear Vertical array transducer. Each element in the transducer 100 generates compression waves 101 at an angle with regards to the part inspected 102. The ultrasound is coupled into the part using a liquid couplant 103. The difference in ultrasound velocity with the part generates refracted shear waves 104 which are present from the first critical angle of 30° 105 to the second critical angle of 60° 106.

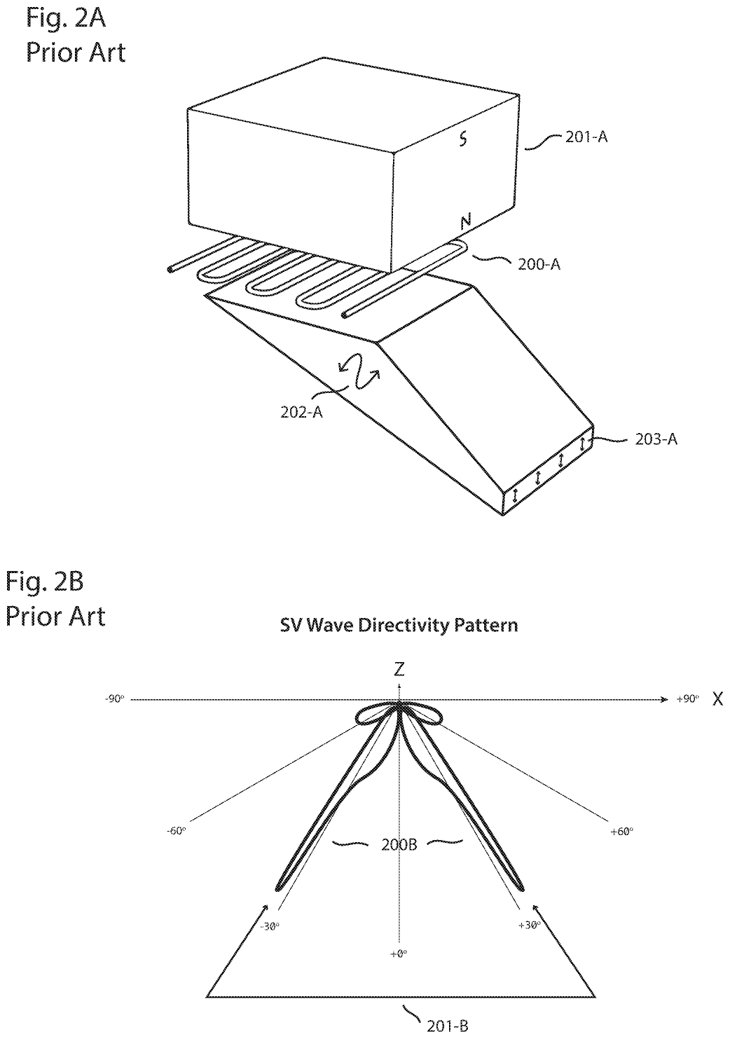

FIG. 2A shows a standard construction for a Shear Vertical EMAT transducer. A meandering RF coil 200-A with meanders half a wavelength apart is positioned under a normal magnetic field 201-A. The interaction between the magnetic and the electrical field generate a shear particle motion in the material with vertical polarization with regards to the plane of generation 202-A thus generating a Shear Vertical wave front 203-A.

FIG. 2B shows the directivity pattern and relative strength of the wave generated at different angles when sweeping a Shear Vertical wave 200-B generated with EMAT, which is highest at +/−35° 201-B and weak or non-existing at other angles.

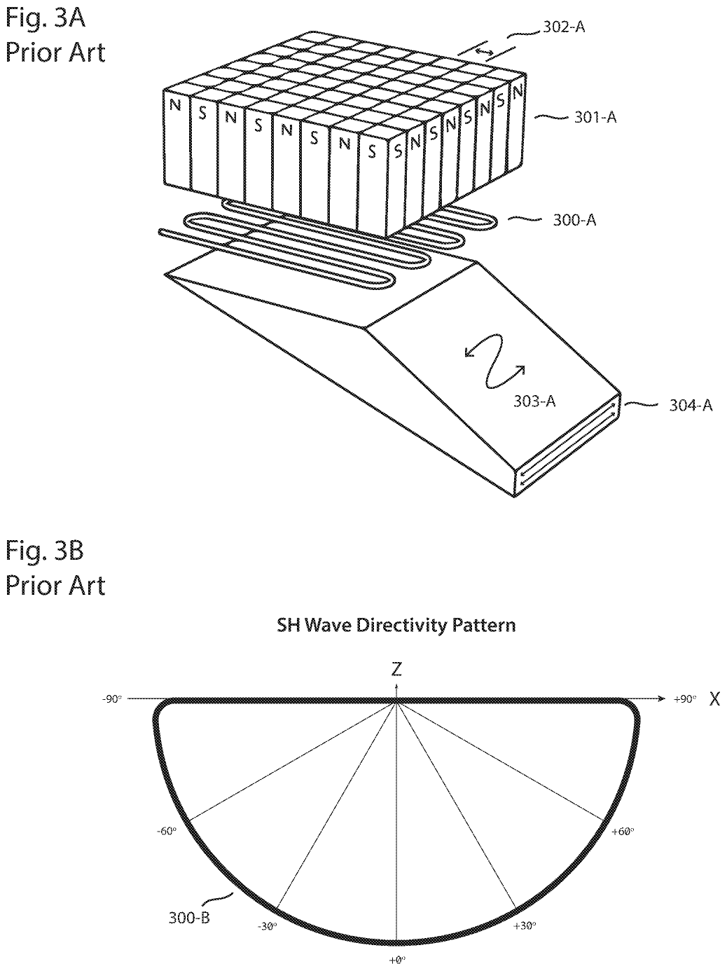

FIG. 3A shows a standard construction for a Shear Horizontal EMAT transducer. A meandering RF coil 300-A is positioned under a magnet array with alternating poles 301-A that keep the polarity constant on each row of the meander coil. Additional rows spaced by half a wavelength from center to center 302-A strengthen the mode at that particular wavelength. The interaction between the magnetic fields and the electrical fields generate a shear particle motion in the material with horizontal polarization with regards to the plane of generation 303-A thus generating a Shear Horizontal wave front 304-A.

FIG. 3B shows the directivity pattern and relative strength of the wave generated at different angles when sweeping a Shear Horizontal wave generated with EMAT 300-B, which is present at all angles from 0° to +/−90°.

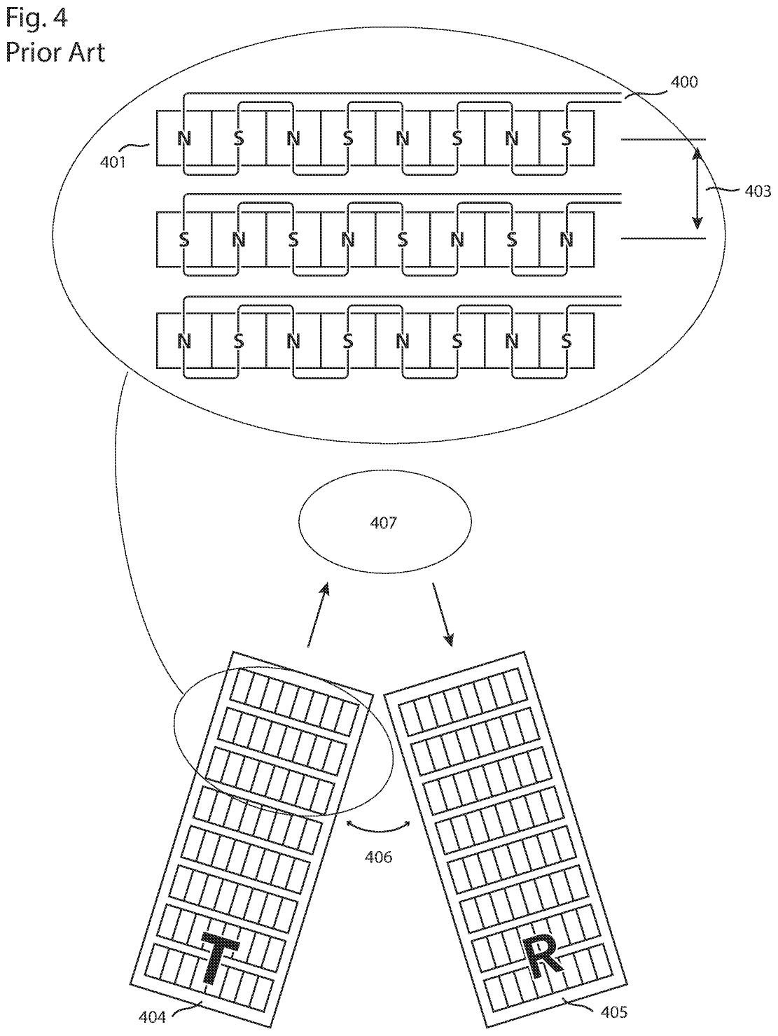

FIG. 4 shows an eight (8) channel conventional construction for a Shear Horizontal phased array EMAT in with each meandering RF Coil element 400 is crisscrossed by magnets of alternating poles 401 over each meander. The separate elements 402 are combined to create a phased array. The pitch of the array is the distance from pole to pole for each row of magnets 403. The construction requires using different elements for transmission 404 and reception 405 which are positioned at an angle 406 to address the area of interest 407.

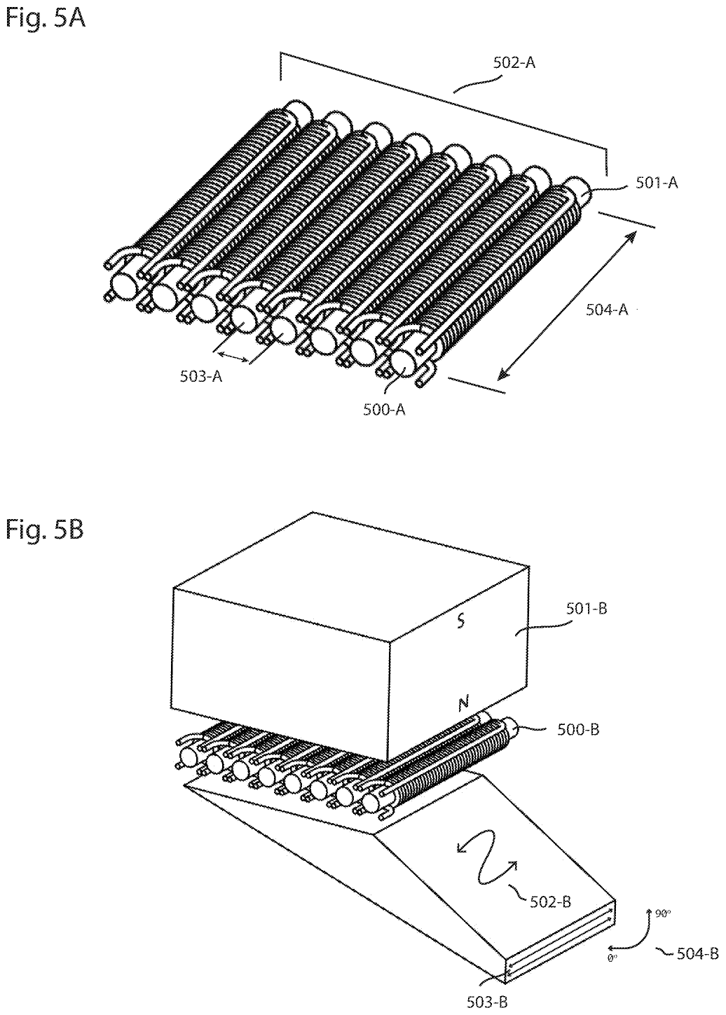

FIG. 5A shows an example of an eight (8) RF coil array for the novel phased array transducer. The RF coil elements are made by individually winding spools of non-conductive material 500-A with two coils of wire in which two ends are tied together for the ground, and the other two ends are tied to the north and south poles of the instrument 501-A. The wound spools are placed side-by-side to form the array 502-A. The distance from spool center to spool center is the pitch of the transducer 503-A, while the length of the spool wound is the width of the transducer, also known as passive plane or elevation 504-A.

FIG. 5B shows the RF coil array 500-A under a normal magnetic field 501-B. The interaction between the magnetic and the electrical field generate a shear particle motion in the material with horizontal polarization with regards to the plane of generation 502-B thus generating a Shear Horizontal wave front 503-B. By timing the pulsing and receiving of each element, these Shear Horizontal waves can be electronically focused at any angle from 0° to +/−90° 604 from the normal.

What is claimed is:

1. A system, comprising
a plurality of RF coils each one built by winding a single layer coil of wire around and along a spool, and stacked aside each other to form an RF coil array;
a magnet or magnet arrangement that generates a single normal field that is applied over said RF coil array;
a pulser-receiver instrument configured to generate a time-varying current in the RF coils that can be programmed to pulse all RF coils independently from each other, and receive the information back from the RF coils independently from each other.

2. The system of claim 1, wherein the time-varying currents in the RF coils generate eddy currents on the surface of a nearby conductive material that interact with the static magnetic field generating ultrasonic shear waves perpendicular to the direction of the wire coiling, and radiating in all directions perpendicularly to the spool with horizontal polarization from the plane of generation.

3. The system of claim 1, wherein said wound spools are placed side by side to create an array in which each RF coil becomes a single element that can be pulsed independently from the others, and collect received signals also independently from the others.

4. The system of claim 1, wherein the winding is a single wire.

5. The system of claim 1, wherein the winding consists of two separate wires in which the end on one wire is connected to the beginning of the other wire and tied to ground, and the other two wires become the positive and negative poles in a differential coil construction.

6. The system of claim 1, wherein the magnetic field is generated with a single permanent magnet positioned on top of the RF coil array exerting a normal magnetic field over all the RF coils in the array.

7. The system of claim 1, wherein the magnetic field is generated with an array of magnets or an electromagnet exerting a normal magnetic field over all the RF coils in the array.

8. The system of claim 1, wherein the spools are round with diameters that can range from 0.5 mm to 5 mm and lengths that can vary from 5 mm to 250 mm.

9. The system of claim 1, wherein the spools are rectangular and stacked side by side with the shortest dimension placed facing the part where the ultrasound is generated so as to keep the looping return wires farther away from the part.

10. The system of claim 1, wherein the spools are made of a soft magnetic material with high resistivity that helps bringing the overlaying normal magnetic flux into the part with low eddy current losses from the wound coil.

11. The system of claim 1, wherein the RF coil is printed on a multi-layered printed circuit board substrate in which the board substrate acts as the spool.

12. The system of claim 3, wherein the elements of the array used for transmitting the pulsed signal are the same as the ones receiving the signal in a pulse-echo configuration.

13. The system of claim 3, wherein the elements of the array used for transmitting the pulsed signal are different from the ones receiving the signal in a pitch-catch configuration.
